(19) United States
(12) Patent Application Publication
(10) Pub. No.: US 2005/0061887 A1
(43) Pub. Date: Mar. 24, 2005

(54) Barcode verification system and method

(76) Inventors: Kevin Garrison, Atlanta, GA (US); Richard Stamper, Norcross, GA (US)

Correspondence Address: LAW OFFICE OF MICHAEL P. EDDY, #510, 2683 VIA DE LA VALLE, SUITE G, DEL MAR, CA, 92014, US

(21) Appl. No.: 10/668,922

(22) Filed: Sep. 23, 2003

(51) Int. Cl. G06K 7/10; G08C 21/00

(52) U.S. Cl. 235/462.07

(57) ABSTRACT

This invention in one aspect consists of a method of verifying barcode data, comprising the steps of detecting the presence of barcode data in a digital file, obtaining measurements of the bars and spaces of said barcode data, identifying the type of barcode data present in said file, decoding said barcode data using a predetermined algorithm used for that type of barcode data, verifying said barcode data using the result of the decoding step, and outputting the results of the verification. In another aspect, the invention is a system for verifying barcode data, comprising a detector for detecting the presence of barcode data in a digital file, a measurer for obtaining measurements of the bars and spaces of said barcode data; an identifier for identifying the type of barcode data present in said file, a decoder for decoding said barcode data using a predetermined algorithm, a verifier for verifying said barcode data; and a communicator to output the results of the verification.

### CROSS-REFERENCE TO OTHER RELATED PATENT APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND OF THE INVENTION

Barcodes are found on most consumer commercial products, and they are found in three basic forms: printed such as on labels and tags, film negatives or positives used to make printing plates, and digital forms used in graphic design. Manufacturers, distributors and retailers use bar codes to increase efficiency in product management and distribution. Previously, once a bar code was designed and printed for placement onto a product, the printed barcode had to be individually scanned and verified. In order to insure quality and scannability, barcodes must be “verified” prior to final usage. Verification tests the code for encodation, magnification, the width of the narrow bar, the bar width adjustment and quiet zones. A barcode verifier, a piece of hardware that resembles a scanner, is equipped to perform these verification tests. If any problem was encountered with the barcode's scannability, the barcode would be redesigned, reprinted, and retested again. More recently, graphic design techniques have incorporated the use of entirely digital processes for designing, approving, and eventually printing artwork. Even with these recent techniques, verification still entails designing the barcode, printing the designed bar code onto a proof page, and scanning the barcode proof into a bar code reader in order to verify that the printed barcode returns a correct result. Even in instances where using graphic software, when the barcode is found to be invalid, the bar code design process is repeated until the desired finished bar code product is obtained.

Most traditional barcode verifiers work by physically obtaining the different combinations of widths from the bars and spaces in the barcode on a scanned printed document. The barcode verifier does this through the use of a light sensitive wand or laser gun to “sense” the different levels of print contrast also known as light reflectance that represent a “black” bar or “white” space as it passes over a barcode. To accurately read a barcode, the scan must be performed with a consistent speed so that the measurements of the bars and spaces in relation to each other will be recognized by the scanner. The series of widths obtained from a successful scan of a barcode can then be applied to a decoding algorithm that contains logic to understand the many different bar code types that exist, and once the barcode is identified, the measurements are decoded with the appropriate decoding algorithm. Among the many examples of different types of barcodes are the UPC, the Code 128, and the I 2 of 5 barcodes.

Another concept known in those skilled in the art of creating barcode artwork is known as Bar Width Adjustment, also called BWA. BWA is important for creating barcode symbols that will function properly. When creating a barcode symbol, the type of printing process to be used determines what BWA should be used in order to compensate for any ink spreading, bleeding, gain, or loss that may occur when the barcode symbol is printed. If ink spreading is not taken into account during the pre-press stages of designing a barcode, there is a high probability that the bars making up a barcode, when printed, will increase or decrease (more often increase) in size due to this same ink gain. This spreading of ink is one known cause of why barcodes grow “out of specification” from known tolerance ranges of properly printed barcode symbols. The commonly accepted standard in the barcode creation industry is to measure BWA in terms of “Mils” or 1/1000th of an inch. Other measurements returned after scanning a barcode are items such as quiet zones and narrow bars which are additional important space and size related details of certain barcode symbols.

Companies within the graphics, printing, packaging and publishing industries which use bar codes strive to streamline their production cycles. Recent developments in technology such as PDF proofs, digital workflows, and DTP (Direct to Press/Direct to Plate) technologies have helped printers respond to the market's demands for faster turnaround times, lower costs, and shorter run lengths. Also, in recent years, industry associations, such as the IPA (Association of Graphic Solutions Providers) and NPES (Association for Supplier Printing, Publishing, and Converting Technologies), have focused their efforts toward creating standards that enable printers to gain efficiency by utilizing PDF documents throughout the entire workflow.

A major problem in the pre-press workflow has been in having to interrupt the digital process in order to output and verify a printed barcode. There is a great need to verify digital barcodes “online” prior to a printing plate being made or prior to a print job as companies involved specifically in the production of barcodes move deeper into a paperless workflow environment.

### BRIEF SUMMARY OF THE INVENTION

The present invention disclosed herein relates to a system and method used in the production of barcodes to indicate whether distortions capable of distorting the widths of bars and spaces in a barcode will occur to an extent such as to bring the final produced barcode out of specification. The present invention allows barcodes to be verified and proofed without producing paper or film, without the use of a physical device and can be done pre-press—thus saving time and money and increasing the quality of work product. With this invention, it is possible to spot problems before a proof printing or a printing run and to take corrective action. The present invention also allows the tracking of the barcodes and barcode files themselves.

Accordingly, in its broadest aspect, the present invention provides a method verifying barcode data, comprising the steps of detecting the presence of barcode data in a digital file, obtaining measurements of the bars and spaces of said barcode data, identifying the type of barcode data present in said file, decoding said barcode data using a predetermined algorithm used for that type of barcode data, verifying said barcode data using the result of the decoding step, and outputting the results of the verification.

The invention also further comprises an additional step of creating and storing meta data relating to said barcode data. It also comprises the broadest aspects with the additional step of retrieving, receiving and storing aspects of the barcode data as well as related data into a database.

Also, in another aspect, the invention is a system for verifying barcode data, comprising a detector for detecting the presence of barcode data in a digital file, an identifier for identifying the type of barcode data present in said file, a measurer for obtaining measurements of the bars and spaces of said barcode data, a decoder for decoding said barcode data using a predetermined algorithm, a verifier for verifying said barcode data; and a communicator to output the results of the verification.

The system also further comprises either a meta data creator for creating and storing meta data relating to said barcode data or a database for retrieving, receiving and storing information related to said verification of barcode data.

### BRIEF DESCRIPTION OF THE SEVERAL VIEWS OF THE DRAWINGS

The above and other objects, advantages and features of the present invention will be more readily apparent from the following description, when read in conjunction with the accompanying drawings wherein:

FIG. 1 is a sample view of the system and method used in accordance with the claimed subject matter.

### DETAILED DESCRIPTION OF THE INVENTION

In order to utilize the present invention in its present embodiment, one must have a computer, graphic design software, and a file containing a barcode symbol. Preferably the file includes at least one barcode symbol, but more than one barcodes may be present in the file. The barcode symbol is typically made up of a group of bars and spaces. Using the X and Y coordinates built in to graphic arts programs, the various widths of bars and spaces can be obtained from this barcode symbol. These widths, when applied to an appropriately compiled decoding algorithm, represent numbers and letters in the exact same fashion as one would obtain when using a physical hardware scanner and its associated software. Some examples of hardware and software are the HHP Quick Check 600 and 800, the RJS D4000, and the RJS Inspector 2000 and 3000 models.

In the present invention, the measurements are obtained using a computer assisted algorithm applied to the coordinates obtained from a digital file rather than a scanning device and software algorithm combination. In using a pure digital system and method, as in the present embodiment, accuracy is increased due to the higher precision of measurements. For example, while usable measurements in the range of 1/1000 thousandth of an inch are obtainable, much more precise measurements of up to 1/10,000 or 1/100,000 of an inch are also obtainable. The preferable range in the present embodiment is 1/1,000 to 1/10,000 of an inch. Additionally, the present invention avoids issues of operator error found in the process of physically scanning of barcodes such as the variable speed and variable distances at which a person scans a barcode symbol when using a physical scanning device. These variables are eliminated with the present invention's system and method.

In the instant embodiment, the barcode symbol is stored along with other data related to the symbol in an Encapsulated PostScript File Format, a file specification developed by Adobe and also known as an EPS file. An EPS file is a set of code just like any other electronic or digital file. When used in the present embodiment, the barcode is created, retrieved and displayed in Adobe's Illustrator and Adobe's Acrobat programs, which are currently some of the most commonly used graphic design programs. The present invention is not limited to Adobe products, but rather it can be adapted to other popular graphic arts programs such as Macromedia Freehand, Quark Express, and Barco Graphics, or any other program capable of obtaining X and Y coordinates or measurements.

The invention can also recognize and decode a number of barcode types and new types can be easily integrated into the invention. For instance, newly released barcode type algorithms, required to decode the new barcode symbols, are able to be imported into the system and method via downloads on the Internet or through physical updates. Some examples of different types of barcode symbols in current use are the 2D barcode symbols such as the Datamatrix, PDF-417, or Aztec codes, and the linear symbols such as RSS (Reduced Space Symbology). One aspect of the invention is to provide a means for end users to update the barcode algorithms, such as downloading via subscription through a website, so that all commercially used barcodes, current as well as newly introduced, can be easily integrated into the system and method.

Another aspect of the invention is that users are able to capture variable data when creating a barcode, or when viewing a barcode already created by someone else, and store that variable data inside the same EPS file, or any other type of suitable file, for future retrieval. The invention can recognize the difference between Encapsulated Post Script information and this variable data, also known as Hidden Meta Tags or Meta Tags, and display them accordingly to an end user. This aspect of the invention addresses user's concerns about the management of large numbers of barcodes in digital form, such as concerns raised by organizations such as the United States Federal Drug and Food Administration, found in 21 C.F.R. Part 11, about quality control and accountability regarding the manufacturing of materials involved with the consumer market.

Meta Tags can be displayed upon verifying a barcode with the present embodiment, along with the quality measurements and encodation of the actual barcode, and can be electronically transferred to a secure location such as a database server for future reference and access. This feature can ensure an even higher level of control and accountability for actions concerning the creation and use of barcodes in settings such as the administration of drug dosages to patients in a medical hospital.

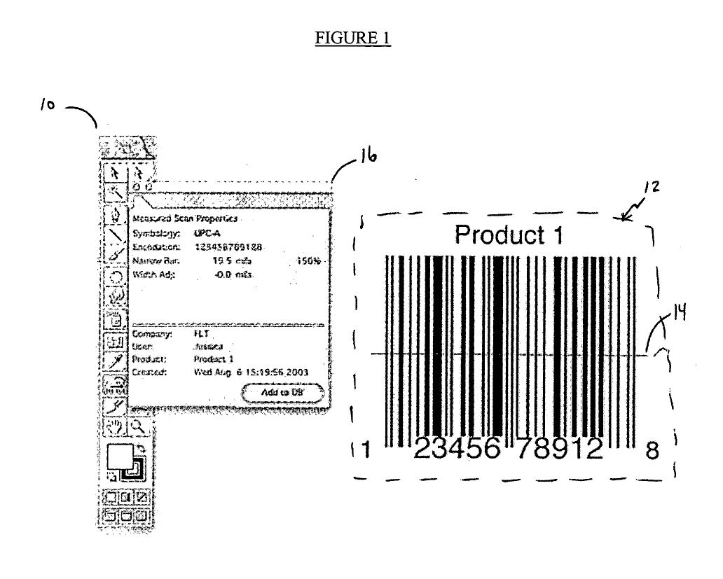

FIG. 1 shows the invention as implemented with an Adobe Illustrator program. Toolbar 10 is a typical toolbar found in a number of Adobe Acrobat programs and which contains multiple buttons for various uses. Barcode symbol 12 is shown as it would commonly be found in an EPS file and which would be displayed in an Adobe program such as Adobe Acrobat or Adobe Illustrator. The trace 14 shows a user's path over a barcode symbol 12 when a user drags his or her input device such as a mouse or track pad over the barcode in order to identify the contents of a particular barcode symbol 12. The barcode symbol 12 can also be found and identified automatically by the present invention so that the information regarding the barcode, including meta-data, is automatically displayed, stored to the same file or stored in a different output file, or any combination thereof.

Pop-up window 16 displays the properties of the barcode symbol found in the EPS file. The window 16 can automatically pop-up when a barcode symbol 12 is found in a graphic file or it can pop-up when the user traces over a barcode symbol 12 as is shown being done in trace 14. This window 16 can also automatically be brought up when the program identified a barcode symbol in a file being opened, or it can be brought up when a user selects a button to bring up the display.

Pop-up window 16 can contain or display various properties of barcode symbol 12. In the present embodiment, these barcode properties include symbology, encodation, narrow bar, and width adjustment. Window 16 also displays meta data information that is related to barcode symbol 12 such as company name, user name, product name, and the date of creation of barcode symbol 12. Other meta data can include the date of last access and the ability to password protect changes in the barcode symbol 12. The properties, meta-tag information along with the barcode itself can be stored into a database for later retrieval, sorting and viewing. Other commercially available database applications can perform a number of functions to aid in the management of the information related to barcode symbol 12.

1. A method of verifying barcode data, comprising the steps of:
detecting the presence of barcode data in a digital file;
obtaining measurements of the bars and spaces of said barcode data;
identifying the type of barcode data present in said file;
decoding said barcode data using a predetermined algorithm used for that type of barcode data;
verifying said barcode data using the result of the decoding step, and
outputting the results of the verification.

2. The method of claim 1, further comprising creating and storing meta data relating to said barcode data.

3. The method of claim 1, further comprising retrieving, receiving and storing aspects of the barcode data as well as related data into a database.

4. A system for verifying barcode data, comprising:
a detector for detecting the presence of barcode data in a digital file;
a measurer for obtaining measurements of the bars and spaces of said barcode data;
an identifier for identifying the type of barcode data present in said file;
a decoder for decoding said barcode data using a predetermined algorithm;
a verifier for verifying said barcode data; and
a communicator to output the results of the verification.

5. The system of claim 4, further comprising a meta data creator for creating and storing meta data relating to said barcode data.

6. The system of claim 4, further comprising a database for retrieving, receiving and storing information related to said verification of barcode data.
